(19) United States
(12) Patent Application Publication
(10) Pub. No.: US 2019/0225921 A9
(43) Pub. Date: Jul. 25, 2019

(54) METHOD FOR PRODUCING A LIQUID, SURFACTANT-CONTAINING COMPOSITION

(71) Applicant: Henkel AG & Co. KGaA, Duesseldorf (DE)

(72) Inventors: Luca Bellomi, Duesseldorf (DE); Frank Meier, Duesseldorf (DE); Sheila Edwards, Duesseldorf (DE); Matthias Sunder, Duesseldorf (DE); Gerd Boesemann, Duesseldorf (DE)

(21) Appl. No.: 15/849,055

(22) Filed: Dec. 20, 2017

Related U.S. Application Data
(63) Continuation of application No. PCT/EP16/64119, filed on Jun. 20, 2016.

(30) Foreign Application Priority Data
Jun. 30, 2015 (DE) 102015212131.3

(51) Int. Cl. C11D 11/00; C11D 11/04; B01F 3/12

(52) U.S. Cl. CPC C11D 11/0094; B01F 3/1207; C11D 11/04

(57) ABSTRACT

A method for producing a liquid composition which contains surfactants, and to the compositions obtained by the method.

### FIELD OF THE INVENTION

The present invention relates to a method for producing a liquid composition which comprises surfactants as well as the compositions obtained by said method.

### BACKGROUND OF THE INVENTION

Liquid, surfactant-containing compositions are becoming increasingly indispensable in everyday life. On the one hand, these are personal-care products, such as for example shampoos, shower gels or bubble baths. But also washing or cleaning agents, such as household detergents, softeners, washing agents for laundry, floor-care products, all-purpose cleaners, manual dishwasher detergents, automatic dishwasher detergents or heavy-duty detergents are encompassed by this.

Nowadays, a large part of these compositions is produced in a batch process. The batch process, often also called batch production, is a discontinuous production method. For this, specific quantities of substances used according to a predetermined composition are conveyed into a container and mixed there. The load capacity of the production vessel in which all components are mixed limits the quantity of material which is produced in a batch.

In a typical batch process firstly a reaction vessel is completely filled with the starting materials, i.e. the educts. The educts react to create the end product within the reaction vessel. If the reaction which may be taking place has finished, the reaction vessel is completely emptied and the desired formulation is poured into suitable containers for sale or optionally for storage. Then, the reaction vessel must be prepared for the next filling. This means a thorough cleaning of the reaction vessel as well as optionally the lines via which the starting products are introduced into the reaction vessel, as well as carrying out upcoming maintenance.

Such a batch process has the advantage that the formulation of the composition can still be adapted in the reaction vessel, if necessary. Additional dosages of individual components are possible here. In terms of quality aspects, it is to be taken into account here that there is a possibility of batch traceability.

The disadvantage is, however, the large amount of space required. A reaction vessel is always completely filled, i.e. large quantities of a product are always produced. If a batch is produced, it must firstly be processed before a further batch can be started. If direct further processing or filling is not possible, an already produced product must be stored outside of the reaction vessel. Also, this leads to a large amount of space being required, as well as to further costs arising.

Furthermore, the change in production from one product to another requires great outlay. If for example a product is produced in a first batch process, which product has a specific dye and a specific odorant then, before a second product with a different dye and odor profile is produced, the reaction vessel and all supply lines must be deep cleaned, in order to prevent contamination of the batches.

The disadvantage in the batch process is also that different components are included which are stable at different temperatures. If for example enzymes are included, a temperature of 40° C. cannot be exceeded as otherwise these degrade. Also, inside a batch, stirring can take place only at a specific shearing force. However, different shear forces are necessary for different components in order to distribute these homogeneously.

With regard to specific solvents which are slightly volatile, likewise a closed system would be advantageous. However, in the batch process, work takes place conventionally with open reaction vessels. If the mixture contained therein is heated, slightly volatile compounds can escape and reach the environment, which may be dangerous. Additionally, in undesired manner, specific balances can be displaced in the batch. Depending on the escape of solvents, specific components can thereby precipitate out, or balance states between products be displaced. Since, in the open system, escape depends on external conditions, an undesired variation of batch product qualities thus occurs.

In addition to the discontinuous batch process, continuous methods for producing liquid, surfactant-containing compositions are also known. Continuous processes offer better possibilities for just-in-time production. However, an expensive control of the individual process steps is necessary here. In the continuous process, the thorough mixing by means of static or dynamic mixing devices does not take place in a reaction vessel, as in the batch process. Instead, thorough mixing takes place within a line. The individual ingredients of a formulation are fed in a predefined sequence in this line. Filling takes place directly at the end of this line. Subsequent filling or changing of the concentration of individual components is not possible here. A targeted and controlled monitoring of the addition of each individual component is necessary.

When producing personal-care products, washing or cleaning agents, it is also to be borne in mind that adding solid components may be necessary. However, these can only be added in a batch process. Adding solid components in a continuous method is not possible. In continuous methods, only liquid components can be added.

Adding solid additives to corresponding compositions is part of current prior art. Suspending solids in stable manner in liquids is frequently problematic, in particular if the solids differ from the liquid in respect of density, whereby they tend to sediment or float. Also, working-in of specific active ingredients (for example bleaching agents, enzymes, perfumes, dyes etc.) in liquid washing and cleaning agents can lead to problems. For example, intolerances between the individual active-ingredient components of the liquid washing and cleaning agents can occur. This can lead to undesired discolorations, agglomerations, odor problems and damage to active ingredients which are active in the wash.

However, consumers require liquid washing and cleaning agents which also optimally produce their effect at the time of application after storage and transport. This is contingent on the ingredients of the liquid washing and cleaning agents having neither broken down in advance, or decomposed, or volatilized. One concept for the working-in of sensitive, chemically or physically incompatible and volatile components is the use of particles and in particular microcapsules in which these ingredients are included in storage-stable and transport-stable manner.

### BRIEF SUMMARY OF THE INVENTION

Therefore, there is a need to provide a method with which liquid surfactant-containing compositions can be produced. In so doing, consideration should in particular be given to the fact that mixtures produced in the batch process are frequently unstable at low temperatures. Often, this then leads to coagulations, whereby a homogeneous product cannot be produced. On the other hand, low temperatures are required for some components of the composition.

Surprisingly a method has been developed in which a mixture is produced in a batch method in a first step, which mixture is then further processed in a second step in a continuous method, wherein, at the start of the continuous method, the mixture has a temperature of 35° C. or more, and in the second step a cooling takes place, which achieves the object forming the basis of the invention.

A material, such as for example a composition or mixture is, according to the definition of the invention, liquid if it is present in liquid aggregate state at 25° C. and 1013 mbar. A material is, according to the invention, solid or solid-shaped if it is present in solid aggregate state at 25° C. and 1013 mbar.

The pair of terms surfactant/surfactants, phosphonate/phosphonates, anionic surfactant/anionic surfactants, non-ionic surfactant/non-ionic surfactants and similar terms are intended to have the same meaning and cover both the singular and plural.

The mixture produced in the batch method comprises at least one solvent as well as preferably at least one active substance. An active substance within the scope of the present invention is a substance which in the eventual composition has a specific task. For example, this can be at least one surfactant and/or at least one salt. The composition according to the invention thus comprises at least one solvent, at least one active substance and optionally further components. These further components are components which, because they provide a visual appearance which is attractive to the consumer, are added in the continuous method.

The method according to the invention also makes it possible for the produced mixture firstly to be stored and to be further processed in a continuous method immediately after storage. However, the further processing in a continuous method can take place also directly after production of the mixture in the batch method, which is preferred according to the invention. According to the invention, the proportion of all components of the mixture produced in the batch method is 1 vol.-% to 99 vol.-%, preferably 5 vol.-% to 95 vol.-%, in particular 20 vol.-% to 90 vol.-%, relative to the total volume of the composition. The proportion of all components incorporated in the continuous method is preferably 1 vol.-% to 99 vol.-%, in particular 5 vol.-% to 95 vol.-%, preferably 10 vol.-% to 80 vol.-%. Components are solvents, active substances as well as further components, thus all ingredients of the composition.

Preferably, the method according to the invention is a method for producing personal-care products, washing or cleaning agents, in particular washing or cleaning agents.

The feature that the mixture has a temperature in the region of 35° C. or more at the start of the continuous method means that the mixture which is supplied from the batch tank to the continuous system has a temperature of 35° C. or more upon entry into the continuous system. The temperature of the mixture is determined with a commercially available PT100 resistance thermometer in the batch tank and in the continuous system at the supply line. In the tank, the thermometer is mounted next to the outlet via which the mixture arrives in the continuous system. Usually, when being let out, the mixture in the batch tank has the same temperature as at the time of the introduction into the continuous system. This is tested via a second PT100 resistance thermometer which is mounted in the continuous system at the point at which the mixture is supplied. It is always avoided that the mixture cools below 35° C. between the batch tank and the introduction into the continuous system. Optionally, the temperature of the mixture in the batch tank is set clearly above 35° C. in order to introduce the mixture at 35° C. or more into the continuous system. The mixture is thus not heated again between tank and continuous system, before arriving in the continuous system. Instead, the heat of the batch mixture is utilized in order to supply the mixture, without further heating, into the continuous system at a temperature of 35° C. or more. This is a particular advantage of the present invention as it contributes to saving energy and stabilizing the mixture.

Usually, mixtures are produced at a higher temperature in the batch method. In most methods, this is at 35° C. or more. Frequently, at the end of the batch method, the mixture has temperatures in the range of from 40° C. to 90° C.

The batch temperature is frequently based on the fact that a solvent is used at a temperature of 40° C. or more, in particular of 50° C. or more, preferably of 60° C. or more. These temperatures make it possible for the active substances which are intended to be dissolved in the solvent in the batch method to dissolve well or be distributed therein. According to the invention, the solvent can be introduced into the batch method with a temperature which is higher than room temperature. Within the scope of the present invention, room temperature means 20° C. In addition to the solvent, other substances can also be added to the batch which have one of the above-described temperatures.

However, it is also possible for the solvent and the whole mixture to be heated in the batch method. On the one hand, this can take place by friction forces or shear forces which occur in the batch method upon thorough mixing. Heating elements can likewise be used to heat the mixture in the batch tank. However, exothermic reactions also take place frequently in the batch method, in which reactions additional heat is released, whereby the temperature increases in the stirring tank of the batch method. Corresponding exothermic reactions are for example neutralization reactions which occur if surfactants, in particular anionic surfactants, are produced by neutralizing the corresponding acid.

In this way, acids of the anionic surfactants, which have been disclosed herein, are neutralized with a suitable neutralizing agent in the batch tank or outside of the batch tank. The heat which comes about by the expiry of the neutralization reaction in the tank or by supplying the warm neutralizate increases the temperature of the mixture in the batch. This improves the solubility of the individual components in the mixture.

All substances are suitable as neutralizing agents within the scope of the present invention which can neutralize the anionic surfactant in its acid form, i.e. transfer it into an anionic surfactant acid salt.

The neutralizing agent can be added in liquid or solid state. Neutralizing agents in liquid state includes solutions and suspensions of solid neutralizing agents.

Thus for example alkali hydroxides such as NaOH or KOH, base oxides such as alkali-metal oxides or basic salts such as for example carbonate come into consideration. Further neutralizing agents are ammonia and amines. Preferably, amines are selected, in particular from the group consisting of monoethanolamine, trimethylamine, triethylamine, tripropylamine, triethanolamine, N-methyl morpholine, morpholine, 2,2-dimethyl monoethanolamine, N,N-dimethyl monoethanolamine and mixtures thereof.

Quite particularly preferred are amines as they are quite manageable, with no water emerging upon neutralization. Monoethanolamine is particularly preferred.

The neutralizing agents can be combined with anionic surfactant acids which are customary for washing agents, cleaning agents and personal-care products, in particular with the anionic surfactant acids corresponding to the anionic surfactants disclosed herein.

Neutralizing agents are preferably used in a specific molar stoichiometric ratio to the anionic surfactant acid which enables the complete expiry of the reaction under the chosen reaction conditions. For example, the molar ratio of neutralizing agent to anionic surfactant acid can be 0.5:1 to 10:1, preferably 1:1 to 3:1.

It can be advantageous to heat the anionic surfactant acid and/or the neutralizing agent or the mixture in the batch tank in order to accelerate the start of neutralization.

C₉-C₁₃ alkylbenzene sulfonate, in particular linear C₉ to C₁₃ alkylbenzene sulfonate, is the particularly preferred anionic surfactant acid.

In particular, linear C₉-C₁₃ alkylbenzene sulfonate (LAS acid or HLAS) and monoethanolamines which are preferably components of the mixture (masterbatch) produced in the batch method react with one another accompanied by the development of heat. In a preferred embodiment of the method according to the invention, a neutralization of linear C₉-C₁₃ alkylbenzene sulfonate with monoethanolamine takes place in the batch method.

The particular advantage of the use of monoethanolamine is the prevention of the formation of water as neutralization product. This is significant in particular when producing water-free or low-moisture mixtures and compositions. It is advantageous to produce the anionic surfactants firstly in the batch from the corresponding acids as, on the one hand, the acid is more cost-favorable to acquire and the neutralization heat warms the mixture, with the result that the dissolution of the components in the mixture is accelerated. In specific embodiments, the further targeted supply of heat can be dispensed with, which enables a more economical process sequence. Also, when mixing one or more active substances in a solvent, this can lead to a release of heat. This is preferred in the batch method because, as a result of this, most components are more easily soluble in the solvent.

Additionally, it is known that important raw materials, such as e.g. enzymes, silicones (defoamers), fragrances or solvents with a low flash point, remain stable or can be metered only at temperatures <30° C. in a liquid mass. There is also a high probability that at T>30° C., the degradation of any enzymes contained in the composition occurs clearly more quickly and a deterioration of the product performance is caused as a result. Likewise, at increased temperatures, a silicone emulsion contained as a defoamer can break, with a phase separation in the product taking place as a result. This can result in a foaming of the batch, with the result that a further processing is no longer possible here. According to the invention, therefore, the mixture produced in the batch method is preferably free from defoamers. According to the invention, these can be introduced into the composition in the continuous method Therefore, in one embodiment, the mixture can be provided with defoamers in the continuous method, in particular such that the composition has at least 0.1 wt.-% defoamer. In the batch method, solvent with a low flash point can escape and form an explosive atmosphere as a result, whereby production safety can be endangered, with the result that these are also preferably added in the continuous method.

Enzymes within the scope of the present invention are all suitable enzymes known in washing agent methods, e.g. amylases, lipases, cellulases, pectinases and proteases.

Defoamers within the scope of the present invention are silicones. Preferably, the concentration in the composition is 0.

Silicone oils are particularly preferred.

Suitable silicones are conventional organopolysiloxanes which can have a content of fine-particle silicic acid which in turn can also be silanized. Such organopolysiloxanes are for example described in European patent application EP 0496510 A1. Polydiorganosiloxanes known from the prior art are particularly preferred. Generally, the polydiorganosiloxanes contain fine-particle silicic acid which can also be silanized. In particular, dimethylpolysiloxanes containing silicic acid are suitable.

The temperature of the mixture is reduced by the cooling according to the invention. Preferably, the temperature of the mixture at the end of the continuous method is below 35° C., in particular 25° C. or below. This mixture, obtained at the end of the continuous method, corresponds to the composition according to the invention. This is poured into suitable containers at the end. These can be vessels in which the product is sold to the end-user, such as for example bottles. However, according to the invention it is also possible that the container is a canister or container in which the composition is initially stored. In this case the container is an intermediate store.

In the continuous method, the mixture produced in the batch method can be cooled in different ways. A continuous system in which a corresponding continuous method can be carried out comprises a main line in which the different components of the composition according to the invention are introduced in a predetermined, defined sequence, via secondary feed lines. Furthermore, the highly-concentrated mixture is conventionally diluted using a suitable solvent, conventionally water, in the batch method. Cooling can take place in that the supplied components and the solvent have a lower temperature than that of the mixture. Furthermore, it is also possible that corresponding cooling devices are attached about the main tube in which thorough mixing takes place due to the flow properties. According to the invention, cooling can be direct or indirect. If, in comparison with the mixture, colder components are added to the batch method (masterbatch), this is called direct cooling. If a cooling device or apparatus for cooling is used, the cooling medium (mostly water) does not come directly into contact with the mixture and is therefore called indirect cooling. Plate heat exchangers, tube bundle heat exchangers, double-pipe heat exchangers with or without mixer element in the product side tube are to be named as suitable apparatuses (cooling devices).

In order to make possible an improved thorough mixing, it can be provided to introduce static and/or dynamic mixers into the main line. If static mixers are provided, this can also aid cooling. For this, the static mixers can contain either a material, such as for example a metal or a heat-conductive plastic. It is also conceivable that a suitable coolant will flow through the static mixer, whereby the mixture will be cooled.

The continuous method is characterized in that excess pressure prevails within the system which the continuous method is taking place. The mixture is conducted through a line system. The flow rate of the composition and thus also the pressure in the line system is controlled by means of pumps. Pressure sensors attached to the line system make it possible for the pressure within the line system to be monitored via feedback to the pumps. For example, pressure sensors from Endress and Hauser, Germany, can be used. The main line in which the mixture is conducted or the material flow flowing therethrough is called the main stream. Also, the further active substances or components of the composition are supplied in this main line. The continuous method being subjected to excess pressure also makes it possible to avoid using gas/air. Preferably, the continuous method is carried out at a pressure of 0.1 to 6 bar, in particular from 0.5 to 4 bar, above ambient pressure.

In this continuous method, all materials are metered together in liquid form in a continuous system into the main line, and homogenized by means of dynamic and/or static mixers. Liquid products within the scope of the present invention are liquids or solutions of solids in a suitable solvent as well as stable suspensions, dispersions or emulsions.

The method according to the invention makes it possible to control the temperature over the whole method. Accordingly, at a predetermined temperature individual components or a plurality of components and/or active substances of the composition can be added which takes into consideration the properties of the respective active substance/component. For example saline solutions or other additives for adjusting viscosity can be added at the start of the continuous method. High temperatures are also possible for adding brighteners. Enzymes or dyes are added nearer the end of the continuous method, as at this point the mixture already has a lower temperature than at the start because of cooling.

### BRIEF DESCRIPTION OF THE DRAWINGS

A schematic drawing of a corresponding system (system for carrying out the continuous method) is attached as FIG. 1. FIG. 2 shows a possible further embodiment of a system according to the invention.

FIG. 1 shows a possible embodiment of a continuous system with a dynamic mixer without pre-mixing chamber.

FIG. 2 shows a possible embodiment of a continuous system with a pre-mixing chamber.

### DETAILED DESCRIPTION OF THE INVENTION

Different supply lines are shown, via which components of the composition according to the invention are fed into the main line. By way of example, references 1 to 17 stand for the supply of the following components:
1 Solvent (water or non-aqueous solvent) or masterbatch
2 Solvent (water or non-aqueous solvent) or masterbatch or preservative
3 Solvent, in particular non-aqueous solvent, or auxiliaries for adjusting the viscosity or pH or preservative or masterbatch
4 Solvent, in particular non-aqueous solvent, or auxiliaries for adjusting the viscosity or pH or preservative or masterbatch
5 Solvent, in particular non-aqueous solvent, or auxiliaries for adjusting the viscosity or pH or preservative
6 Solvent, in particular non-aqueous solvent, or auxiliaries for adjusting the viscosity or pH or preservative
7 Solvent, in particular non-aqueous solvent, or auxiliaries for adjusting the viscosity or pH or opacifying agent or color-transfer inhibitors or brighteners or salt solutions
8 Auxiliaries for adjusting the viscosity or pH or opacifying agent or color-transfer inhibitors or brighteners
9 Auxiliaries for adjusting the viscosity or pH or opacifying agent or color-transfer inhibitors or brighteners or salt solutions or co-surfactants
10 Opacifying agents or color-transfer inhibitors or brighteners or salt solutions or co-surfactants or perfume
11 Opacifying agents or color-transfer inhibitors or brighteners or salt solutions or co-surfactants or perfume
12 Auxiliaries for adjusting the viscosity or pH or opacifying agent or color-transfer inhibitors or brighteners or salt solutions or co-surfactants or perfume or dyes or enzymes or salt solutions
13 Return of mixtures from later method steps
14 Opacifying agents or color-transfer inhibitors or brighteners or salt solutions or co-surfactants or perfume or enzymes
15 Perfumes or dyes or enzymes
16 Perfumes or dyes or enzymes
17 Perfumes or dyes or enzymes or surfactants

Also, according to the invention, other or further components can be introduced into the main stream in this or a different sequence, through the respective supply lines. The temperature obtaining in the main stream, the number and position of the mixers as well as the sequence in which the compounds are added are to be considered by a person skilled in the art. According to the invention, via each of the supply lines, only respectively one material is introduced into the supply line. Thus for example via supply line 1 water, and via supply line 2 the masterbatch, and via supply line 3 ethanol can be metered. Alternatively it is also possible that via supply line 1 ethanol, via supply line 2 water and via supply line 3 the masterbatch is metered. The same applies to the further supply lines.

The masterbatch is fed into the continuous system preferably only via one inlet.

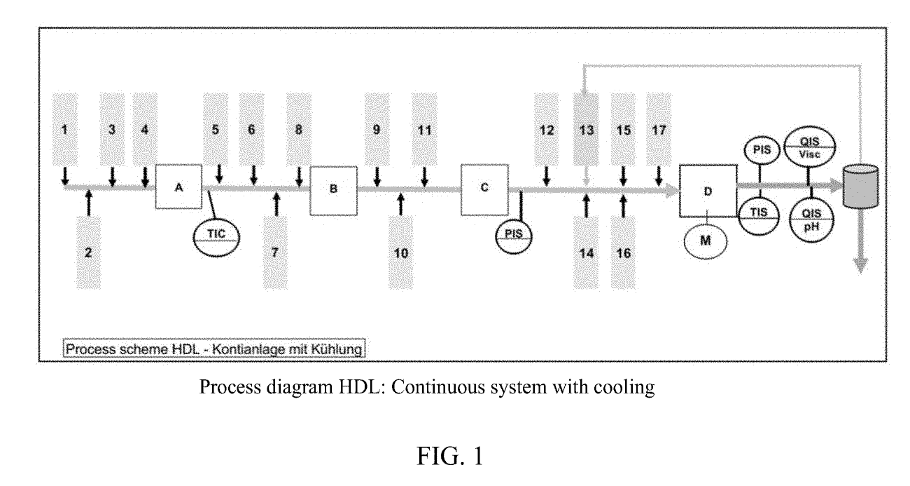

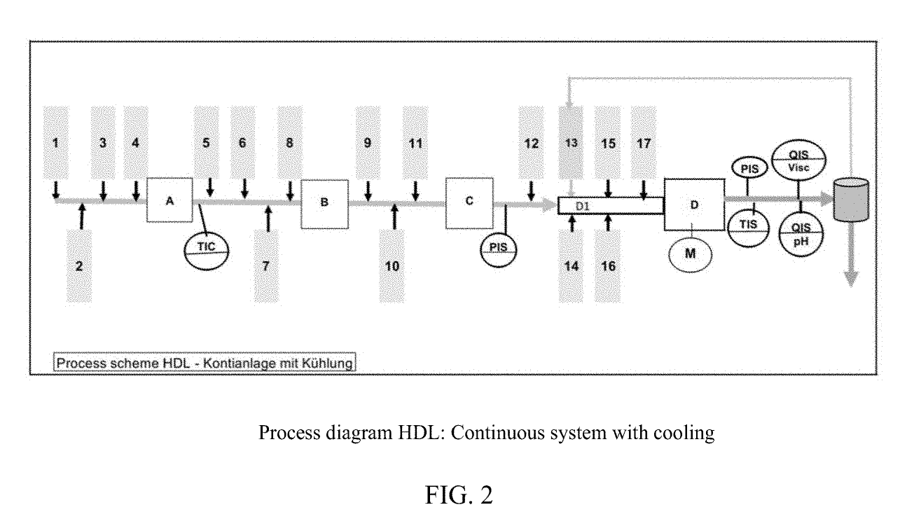

If a continuous system according to FIG. 1 or 2 is used, the masterbatch is introduced as shown above via one of the supply lines 1, 2, 3 or 4. Solvent (water or non-aqueous solvent) is added to the main stream via one of the other supply lines 1 to 4. It is preferred that the masterbatch is introduced into the continuous system via supply line 1 or 2. It is advantageous to meter preservative in one of supply lines 2 to 6, as the substantial portion of the system is then rinsed with preservative.

In the continuous method, the following components are included for controlling the system and regulating the method:
TIC Temperature regulation
TIS Temperature switching point
PIS Pressure monitoring
QIS-Visc Viscosity monitoring and registration
QIS-pH pH monitoring and registration
M Motor
A Heat exchanger—cooler
B Static mixer 1
C Static mixer 2
D Dynamic mixer with
D1 Pre-mixing chamber

In the embodiments shown by way of example in FIG. 1 and FIG. 2, different supply lines for enzymes (14, 15, 16, 17) are shown. All of them are located along the direction of flow within the main line in the second half of the system, and are thus added towards the end of the method. This has the advantage that here the mixture is cooled for example by the cooler (A) and the two static mixers (B, C) and the supply of preferably cold water (1, 2, 3, 4, 5, 6, 7) for direct cooling, with the result that a degradation of the enzymes no longer takes place. In so doing, according to the invention it is possible to meter enzymes via only one of the supply lines (14, 15, 16, 17). It is also possible, according to the invention, to meter enzymes into the main stream via several supply lines. In so doing, the same or different enzymes can be metered via different supply lines. Different enzymes can also be metered via the same lines. The defoamer is metered in the continuous system preferably—as for the enzymes—only if the temperature of the main stream is below 30° C., in order to prevent phase separations. By way of example the defoamer could be introduced via supply line 5, 6, 7, 8, 9, 10, 11 or 12.

Preferably, a cold solvent, in particular cold water is metered into the main stream via at least one of the first supply lines (1, 2, 3, 4, 5, 6, 7). Cold means in this instance a lower temperature than the masterbatch, thus the mixture produced in the batch method. The cold solvent preferably has a temperature in the region of from 7° C. to 20° C. A lower temperature would mean too great a temperature difference in comparison with the masterbatch, which could impair the product properties and make further processing more difficult. Higher temperatures lead to cooling.

Solvents such as water or alcohol solvents such as for example ethanol or propanol are on the contrary preferably added at the start of the method. Cooling likewise takes place as a result. Furthermore, a rapid dilution of the added components is possible. Additionally, due to the solvents a flow is created and maintained in the main stream in particular by the water.

According to the invention it can be provided that the composition is fed back at the end of the main stream after thorough mixing has taken place again in the main stream. In FIGS. 1 and 2 this is shown schematically with supply line 13. As a result, individual components can be re-metered without for example a further dynamic mixer needing to be present. Furthermore, for example the pH or the viscosity or similar properties can be re-adjusted before the composition is then poured in at the end of the method.

According to the invention a pre-mixing chamber (D1) may be present. In this, several raw materials, for example enzymes or other components or active substances can be added simultaneously into the already existing mixture and pre-mixed in a short residence time in this pre-mixing chamber (D1). The eventual thorough mixing of all the components contained in the composition then takes place in the subsequent mixer. The residence time in the pre-mixing chamber is usually 2 seconds or fewer.

According to the invention it can also be provided that cooling takes place not only at the main line by means of cooler (A). It can likewise be provided that the supply lines also include cooling, with the result that for example the mixture produced from the batch method is introduced into the main line via a supply line (1, 2, 3 or 4), wherein the corresponding supply line comprises a cooling device, with the result that a first cooling of the mixture is hereby already taking place. In so doing, the masterbatch is metered into the main stream only via one of the supply lines.

Due to the flow within the main line, this can lead to a drop-in pressure. In order to make possible a uniform filling, the continuous system according to the invention can also have a decoupling container as an atmospheric buffer. This makes possible a constant pressure at the end of the continuous system, with the result that a simple filling is made possible.

The mixture produced in the batch method preferably has a high concentration of the at least one active substance contained therein. Preferably, the active substance is at least one surfactant.

Preferably this is at least one anionic surfactant. The mixture has preferably anionic surfactant with a proportion of from 5 wt.-% to 40 wt.-%, in particular of from 8 wt.-% to 36 wt.-%, particularly preferably of from 10 wt.-% to 30 wt.-% .-%, even more preferably of from 20 wt.-% to 28 wt.-%.

More preferably, the mixture has non-ionic surfactant with a proportion of from 1 wt.-% to 27 wt.-%, in particular of from 10 wt.-% to 26 wt.-%, particularly of from 15 wt.-% to 25 wt.-%.

Anionic surfactants and non-ionic surfactants can be worked into a suitable solvent well in the batch method. This makes possible the production of a mixture with a high concentration of surfactants, wherein the mixture can correspondingly then be diluted in the continuous method depending on the desired end-product. This makes possible a high flexibility in the production of the desired composition.

According to the invention, mixtures, in particular mixtures produced in the batch method which contain at least one surfactant (surfactant mixtures) are conventionally stable only at increased temperature, with the result that preferably the mixture produced in the batch method has a temperature of over 40° C. and, when it has this temperature, is introduced in the continuous method. In so doing it is desirable that a rapid dilution of the surfactant mixture takes place in the continuous method, as otherwise this may lead to a coagulation of the surfactants. In addition to the surfactants, this can also lead to a coagulation of soaps or phosphonates. With specific surfactants, with a slow dilution, a mixture with very high viscosity would be produced which then would no longer be able to be further processed. A rapid dilution can be made possible several times in the continuous method, as the metering of the mixture is simple to monitor in relation to an added metering of water. It is particularly preferred to introduce a high-shear mixer, for example a so-called Pentax mixer, into the continuous system for thorough mixing. A more flexible production of a starting mixture in the batch is thereby possible, as fewer limitations with regard to the batch mixture are now present. Higher concentrated mixtures are thus possible which could be differentiated flexibly by dilution in a continuous system. Moreover, the proportion of solvent in the batch mixture can be reduced, which is why a smaller batch vessel can be used. This saves on investment, cleaning and maintenance costs. Thus the present invention enables the agents to be produced more cost-effectively and efficiently.

The term “phosphonate” is understood here to mean such phosphonates which act as complexing agents in the compositions produced according to the invention.

It should be emphasized that complexing agents are important components of compositions according to the invention. Therefore, it is so advantageous to be able to use phosphonates in larger proportions in the production methods.

In a quite particularly preferred embodiment, the mixture produced in the batch method has a total phosphonate content of from 0.5 wt.-% to 8.0 wt.-%, preferably of from 1.0 wt.-% to 5 wt.-%, even more preferably of from 1.5 wt.-% to 3.0 wt.-%.

The complexing phosphonates comprise, in addition to the 1-hydroxyethane-1,1-diphosphonic acid, a series of different compounds such as for example diethylenetriamine penta(methylene phosphonic acid) (DTPMP). In this application, in particular hydroxyalkane or aminoalkane phosphonates are preferred. 1-hydroxyethane-1,1-diphosphonate (HEDP) is particularly important as co-builder among the hydroxyalkane phosphonates. It is preferably used as sodium salt, wherein the disodium salt displays a neutral reaction and the tetrasodium salt an alkaline reaction (pH 9). Preferably ethylenediamine tetramethylene phosphonate (EDTMP), diethylenetriamine pentamethylene phosphonate (DTPMP) and their higher homologs come into consideration as aminoalkane phosphonates. They are used preferably in the form of neutral reacting sodium salts, e.g. as hexasodium salt of EDTMP or as hepta- and octasodium salt of DTPMP. Preferably HEDP from the class of phosphonates is used as builder. The aminoalkane phosphonates also have a pronounced heavy-metal bonding capacity. Accordingly, in particular if the agents also contain bleach, it may be preferred to use aminoalkane phosphonates, in particular DTPMP, or mixtures of the named phosphonates.

A mixture produced preferably within the scope of this application contains one or more phosphonate(s) from the group
a) Aminotrimethylene phosphonic acid (ATMP) and/or the salts thereof;
b) Ethylenediamine tetra(methylene phosphonic acid) (EDTMP) and/or the salts thereof;
c) Diethylenetriamine penta(methylene phosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) Hexamethylenediamine tetra(methylene phosphonic acid) (HDTMP) and/or the salts thereof;
g) Nitrilotri(methylene phosphonic acid) (NTMP) and/or the salts thereof.

Mixtures which contain 1-hydroxyethane-1,1-diphosphonic acid (HEDP) or diethylenetriamine penta(methylene phosphonic acid) (DTPMP) as phosphonates are particularly preferred. Self-evidently the mixtures according to the invention contain two or more different phosphonates. Preferred mixtures according to the invention are characterized in that the washing or cleaning agent contains at least one complexing agent from the group of phosphonates, preferably 1-hydroxyethane-1,1-diphosphonate, wherein the proportion by weight of the phosphonate in the total weight of the mixture is preferably of from 0.1 to 8.0 wt.-%, preferably of from 0.2 to 5.0 wt.-% and in particular of from 0.5 bis 3.0 wt.-%.

In a further preferred embodiment, the mixture produced in the batch method has a total fatty acid content of from 3.0 wt.-% to 20 wt.-%, preferably of from 5.0 wt.-% to 15 wt.-%, even more preferably of from 7.0 wt.-% to 10 wt.-%.

Stable within the scope of the present invention means that creaming, phase separation, sedimentation, coagulations or spots, stains, cloudings, a milky appearance, solidification or color change are not observed. Preferably, the mixture produced in the batch method (masterbatch) is stable over a period of 1 day or more, in particular of 5 days or more or of 1 week or more, preferably of 2 weeks or more and in particular of 3 weeks or more, preferably of 4 weeks or more, if stored at a temperature of 40° C. or more, in particular of from 40° C. bis 90° C. Preferably, if stored at 40° C., the masterbatch is stable for 2 weeks or longer, in particular 4 weeks.

The composition produced according to the invention is preferably stable over a period of 4 weeks or more, in particular of 8 weeks or more, preferably of 12 weeks or more. In so doing, the composition can be stored at room temperature or a higher temperature, in particular at 20° C. to 40° C. Particularly preferably, the composition is stable when stored at 40° C. over a period of at least 12 weeks.

According to the invention, the composition, and in particular the mixture (masterbatch), can have one or more surfactants. These surfactants are selected from the group which consists of anionic, cationic, zwitterionic, non-ionic surfactants, as well as mixtures thereof. If the composition or the mixture comprises several surfactants, then these can for example be different non-ionic surfactants. However, it is also possible that the composition or the mixture comprises for example both non-ionic and anionic surfactants. The same applies to the other surfactants. Preferably, the composition and/or the mixture comprise at least one anionic surfactant and at least one non-ionic surfactant. If the mixture does not comprise any surfactants, then these are added to the mixture in the continuous method. If the mixture comprises one or more surfactants, if necessary further surfactants can be added in the continuous method.

Anionic surfactants are preferably selected from the group consisting of C₉₋₁₃ alkylbenzene sulfonates, olefin sulfonates, C₁₂₋₁₈ alkane sulfonates, ester sulfonates, alk(en)yl sulfates, fatty alcohol ether sulfates and mixtures thereof. It has been shown that these sulfonate and sulfate surfactants are particularly suitable for producing stable liquid compositions, in particular those with a yield point. Liquid compositions which comprise as anionic surfactant C₉₋₁₃ alkylbenzene sulfonates and fatty alcohol ether sulfates have particularly good dispersing properties. As sulfonate-type surfactants C₉₋₁₃ alkylbenzene sulfonates, olefin sulfonates, i.e. mixtures of alkene and hydroxy alkane sulfonates and disulfonates, as for example are obtained from C₁₂₋₁₈ monoolefins with terminal or internal double bond by sulfonating with gaseous sulfur trioxide and then alkali or acid hydrolysis of sulfonation products, come into consideration. Also, C₁₂₋₈₈ alkane sulfonates and the esters of α sulfo fatty acids (ester sulfonates), for example the α-sulfonated methyl esters of hydrogenated palmitic, palm kernel or tallow fatty acids, are suitable.

The alkali and in particular sodium salts of sulfuric acid semiesters of C₁₂-C₁₈ fatty acid alcohols, for example of coconut oil alcohol, tallow fat alcohol, lauryl, myristyl, cetyl or stearyl alcohol or of C₁₀-C₂₀ oxo alcohols and those semiesters of secondary alcohols of these chain lengths, are preferred as alk(en)yl sulfates. Of interest from a washing-related technical aspect, C₁₂-C₁₆ alkyl sulfates and C₁₂-C₁₅ alkyl sulfates as well as C₁₄-C₁₅ alkyl sulfates are preferred. Also, 2,3 alkyl sulfates are suitable anionic surfactants.

Also, fatty alcohol ether sulfates, such as sulfuric acid monoesters of straight-chained or branched C₇₋₂₁ alcohols, such as 2-methyl-branched C₉₋₁₁ alcohols with on average 3.5 mol ethylene oxide (EO) or C₁₂₋₈ fatty acid alcohols with 1 to 4 EO, which C₇₋₂₁ alcohols are ethoxylated with 1 to 6 mol ethylene oxide, are suitable.

It is preferred that the liquid composition according to the invention and/or the mixture produced in the batch method contains a mixture of sulfonate surfactants and sulfate surfactants. In a particularly preferred embodiment, the liquid composition and/or the mixture produced in the batch method contains C₉₋₁₃ alkylbenzenesulfonates and fatty alcohol ether sulfates as anionic surfactants.

In addition to the anionic surfactant, the liquid composition and/or the mixture produced in the batch method can also contain soaps. Saturated and unsaturated fatty acid soaps, such as the salts of lauric acid, myristic acid, palmitic acid, stearic acid, (hydrogenated) erucic acid and behenic acid as well as those soap mixtures derived in particular from natural fatty acids, for example coconut, palm kernel, olive oil or tallow fatty acids, are suitable.

The anionic surfactants and the soaps can be present in the form of their sodium, potassium or magnesium or ammonium salts. Preferably, the anionic surfactants are present in the form of their sodium salts. Further preferred opposed ions for the anionic surfactants are also the protonated forms of choline, triethylamine, ethanolamine or methylethylamine.

The composition and/or the mixture produced in the batch method can also have at least one non-ionic surfactant. The non-ionic surfactant comprises alkoxylated fatty alcohols, alkoxylated fatty acid alkyl esters, fatty acid amides, alkoxylated fatty acid amides, polyhydroxy fatty acid amides, alkylphenol polyglycol ethers, aminoxides, alkylpolyglucosides and mixtures thereof.

Preferably alkoxylated, advantageously ethoxylated, in particular primary alcohols with preferably 8 to 18 C atoms and on average 4 to 12 mols ethylene oxide (EO) per mol alcohol are used as non-ionic surfactants, in which the alcohol residue can be linear or preferably methyl-branched in 2 position or can contain linear and methyl-branched residues in the mixture, as are conventionally present in oxo alcohol residues. However, in particular alcohol ethoxylates with linear residues made of alcohols of native origin with 12 to 18 C atoms, for example made of coco, palm, tallow fat or oleyl alcohol, and on average 5 to 8 EO per mol alcohol, are preferred. The preferred ethoxylated alcohols include for example C₁₂₋₁₄ alcohols with 4 EO or 7 EO, C₉₋₁₁ alcohol with 7 EO, C₁₃₋₁₅ alcohols with 5 EO, 7 EO or 8 EO, C₁₂₋₁₈ alcohols with 5 EO or 7 EO and mixtures thereof. The indicated degrees of ethoxylation represent statistical averages which can be an integer or a fractional number for a special product. Preferred alcohol ethoxylates have a concentrated homolog distribution (narrow range ethoxylates, NRE). In addition to these non-ionic surfactants, fatty alcohols with more than 12 EO can thus be used. Examples of this are tallow fatty alcohol with 14 EO, 25 EO, 30 EO or 40 EO. Also non-ionic surfactants, which contain EO and PO groups together in the molecule, can be used according to the invention. Furthermore, a mixture of a (more strongly) branched ethoxylated fatty alcohol and an unbranched ethoxylated fatty alcohol, such as for example a mixture of a C₁₆₋₁₈ fatty alcohol with 7 EO and 2 propylheptanol with 7 EO, are suitable. Particularly preferably, the washing, cleaning, post-treatment or washing auxiliary agent contains a C₁₂₋₁₈ fatty alcohol with 7 EO or a C₁₃₋₁₅ oxo alcohol with 7 EO as non-ionic surfactant.

The composition produced according to the invention comprises in the mixture furthermore one or more solvents. This can be water and/or non-aqueous solvent. Preferably, the mixture contains water as main solvent. The mixture produced in the batch method can also comprise non-aqueous solvents. Suitable non-aqueous solvents comprise mono- or polyvalent alcohols, alkanolamines or glycol ethers. Preferably, the solvents are selected from ethanol, n-propanol, i-propanol, butanolene, glycol, propanediol, butanediol, methylpropanediol, glycerol, diglycol, propyldiglycol, butyldiglycol, hexyleneglycol, ethyleneglycol methyl ether, ethyleneglycol ethyl ether, ethyleneglycol propyl ether, ethyleneglycol mono-n-butylether, diethyleneglycol methyl ether, diethyleneglycol ethyl ether, propyleneglycol methyl ether, propyleneglycol ethyl ether, propyleneglycol propyl ether, dipropyleneglycol monomethyl ether, dipropyleneglycol monoethyl ether, methoxytriglycol, ethoxytriglycol, butoxytriglycol, 1-butoxyethoxy-2-propanol, 3-methyl-3-methoxybutanol, propyleneglycol-t-butylether, di-n-octylether and mixtures of these solvents.

If the composition according to the invention has one or more also non-aqueous solvents, in particular those with low vapor pressure, such as for example ethanol or 2-propanol, these are preferably added to the mixture in the continuous method. In the continuous method, work takes place in a closed system, with the result that the corresponding solvent cannot evaporate. Damage to the environment is thus reduced, and almost eliminated. According to the invention it is also possible that water or other suitable solvents are introduced in the continuous method, regardless of their vapor pressure.

The present method has the advantage that a composition can be contained in which the individual components can be metered such that they are exposed only to the temperature at which they are stable. Additionally, effective cooling and dilution can take place. Cooling a vessel from a batch method is dependent on the difference between the temperature which prevails in the vessel and the ambient temperature. Accordingly, cooling of a mixture which has a temperature of 40° C. and in particular of 35° C. is lengthy and time-consuming. The cooling from for example 90° C. to 40° C. takes place relatively rapidly. Further cooling then to approximately room temperature, at which preferably filling takes place, however, takes a very long time. Filling at room temperature is therefore desirable, as the containers usually comprise plastic, with the result that a deformation of the containers can occur at higher temperatures. Cooling in the batch method is usually possible only at the edge of the container, which is why, however, the whole mixture is not cooled, but merely the part of the mixture which is in contact with the edge of the container.

The continuous system makes possible an effective cooling, a rapid dilution, and a thorough mixing adapted to the components introduced. On the basis of one permutation of static and dynamic mixers within the main line, which is preferred according to the invention, a particularly effective thorough mixing of all active substances and components can be achieved. The active substances or components can now be metered either directly before the static or before the dynamic mixer(s), with the result that the shearing force required for thorough mixing can be ensured. Components or active substances which are sensitive to the shearing forces can be introduced after the dynamic mixer(s). The method according to the invention thus does not make possible an adapted production, but takes into consideration also the shearing forces acting on the components, with the result that mechanical load can also be monitored. Thus for example solids which are intended to be suspended in stable manner in the liquid, surfactant-containing composition, can be introduced into the main line after the last dynamic mixer and preferably before the last static mixer.

In a further embodiment, the present invention relates to a liquid, surfactant-containing composition which has been obtained according to the above-described method. Preferably, the composition is a composition with a yield point. It is particularly preferred if the composition has a yield point of from 0.01 to 50 Pa. In rheology, yield point means the shear stress (in Pa) below which a sample is exclusively or at least extensively elastically deformed and above which an irreversible plastic deformation, thus a flow, takes place.

The yield point of the liquid, surfactant-containing composition is measured with an absolute measuring rotational rheometer from TA Instruments, called AR G2 (shear-stress controlled rheometer, cone-plate measuring system with a 40 mm diameter, 2° cone angle, 20° C.). This is a so-called shear stress-controlled rheometer. Here, the samples in the rheometer are charged with a shear stress σ⁻(t) increasing with time. For example, the shear stress can be increased in the course of 30 minutes from the smallest possible value (for example 0.01 Pa) to for example 100 Pa. The deformation γ of the sample is measured as a function of this shear stress σ⁻. The deformation is plotted in a double-logarithmic plot against the shear stress (log γ against log σ⁻). Where the examined sample has a yield point, this can be recognized by a significant change in the curve. Below a certain shear stress, purely elastic deformation is found. The increase in the curve γ(σ) (log-log-plot) in this range is one. Viscous flow begins above this shear stress, and the increase in the curve is sharply higher. The yield point marks the shear stress at which the bend in the curve takes place, thus the transition from the elastic to plastic deformation. An easy determination of the yield point (=bend in the curve) is possible by applying tangents to the two parts of the curve. Samples without yield point do not have any characteristic bend in the function γ(σ).

The composition according to the invention preferably has a yield point in the region of from 0.01 Pa to 50 Pa, preferably of from 0.1 Pa to 10 Pa, particularly preferably of from 0.5 Pa to 5 Pa. Compositions which have a yield point of at most 10 Pa are particularly preferred. It is particularly straightforward to fill these, and they can be metered well by the consumer.

The composition according to the invention can also comprise builders and/or alkaline substances. These are particularly preferably added to the mixture in the batch method. However, it is also possible that these are added dissolved in a suitable solvent in the continuous method.

For example, polymeric polycarboxylates are suitable as builders. These are for example the alkali metal salts of polyacrylic acid or of polymethacrylic acid, for example those with a relative molecular mass of 600 to 750,000 g/mol.

Suitable polymers are in particular polyacrylates which preferably have a molecular mass of 1,000 to 15,000 g/mol. In turn, from this group, the short-chained polyacrylates which have molar masses of 1,000 to 10,000 g/mol, and particularly preferably of from 1,000 to 5,000 g/mol, are preferred on the basis of their superior solubility.

Furthermore, copolymeric polycarboxylates, in particular those of acrylic acid with methacrylic acid, and acrylic acid or methacrylic acid with maleic acid, are suitable. The polymers can also contain allyl sulfonic acids, such as allyloxy benzene sulfonic acid and methallyl sulfonic acid, to improve water solubility.

As builders which can be contained in the composition according to the invention, there are in particular to be named also silicates, aluminosilicates (in particular zeolites), carbonates, salts of organic di- and polycarboxylic acids and mixtures of these substances.

Organic builders which furthermore may be present in the composition according to the invention are for example the polycarboxylic acids used in the form of their sodium salts, wherein by polycarboxylic acids, those carboxylic acids are meant which have more than one acid function. For example, these are citric acid, adipic acid, succinic acid, glutaric acid, malic acid, maleic acid, fumaric acid, saccharic acids, amino carboxylic acids, nitrilotriacetic acid (NTA), methylglycinediacetic acid (MGDA) and derivatives as well as mixtures thereof. Preferred salts are those of polycarboxylic acids such as citric acid, adipic acid, succinic acid, glutaric acid, malic acid, saccharic acids and mixtures thereof. Preferably, however, soluble builders, such as for example citric acid, or acrylic polymers with a molar mass of 1,000 to 5,000 g/mol, are used in the basic composition.

Alkaline substances or wash alkalis are, within the scope of the present invention, chemicals for increasing and stabilizing the pH of the composition.

In the continuous method, in particular the components of the composition according to the invention are added which characterize the desired end-product. Therefore, the method according to the invention makes possible production of a mixture which then can be differentiated from different products in the continuous method. For this, an effective production of different products takes place, as for several products only one mixture needs to be produced. Additionally, the storage time of the finished, filled products is shorter as in the continuous method the quantity of the produced products can be monitored and adjusted more easily. In contrast to this, a large quantity of a product is produced in the batch method which then should be stored either before or after the filling. This has a large spatial requirement which can be reduced in the method according to the invention.

In the method according to the invention, in particular dyes, perfume compositions, enzymes, perfume capsules, microbeads, opacifying agents, color-transfer inhibitors, brighteners, salt solutions, co-surfactants and water or other solvents are added in particular for diluting in the continuous method.

The further processing of the mixture occurs along the main stream through which the mixture flows from the batch method. In so doing, the active substances or components to be metered can also be premixed and metered into the main stream together, or individually in different combinations of e.g. 2-3 components or active substances metered into the main stream via separate supply lines. In so doing it is preferred that, at the place at which the metering into the main stream takes place, a mixer, in particular a static mixer, is located which ensures the rapid and homogeneous distribution of the metered agents (components and/or active substances) into the main stream. In so doing, for example dyes, microcapsules and perfumes can be metered, separately, into the stream. Seen from the introduction of the basic composition, thus firstly the perfume and in a downstream step the dye can be metered. However, the sequence of metering can also take place in reverse, thus firstly dye and then perfume. In principle, it is preferred to meter such substances as which already change the basic composition in small quantities as the last step. If for example a dye is metered initially into the basic composition and at a later stage the perfume or a different substance, the path taken by the dye through the system is long, with the result that if the composition changes, clearly more cleaning outlay is required in order also to remove the last traces of dye. Therefore, it can be advantageous to meter the dyes in the main stream, in order to make possible a quick and favorable change of the dye. Also, the location of the metering of the perfume is to be determined in this respect. However, visual perception is greater for a consumer than the odor, with the result that if there is any doubt, the dye is to be metered after the perfume in order to prevent the consumer from perceiving unintentional changes in color of the product due to a change in composition.

According to the invention, the further processing takes place in the continuous method in particular by the addition of one or more co-surfactants and/or one or more electrolytes. The micellar structure of the surfactants in the mixture is changed by the co-surfactant(s). This effect can be reinforced by one or more electrolytes. This helps produce a lamellar structure of the surfactants. Corresponding structured washing or cleaning agents with a yield point are described in the prior art, for example in WO 2013/064357 A1. Reference is made to the content of this application in its entirety.

Co-surfactants within the scope of the present invention are amphiphilic molecules with a small, hydrophilic headgroup. In a binary system with water, these co-surfactants are often poorly soluble, or not at all soluble. Accordingly, they also do not form any micelles. In the presence of surfactants of the basic composition, the co-surfactants are incorporated in their associates and thereby change the morphology of these associates. Rod-like micelles and/or disk micelles come from the spherical micelles. If the overall surfactant content is sufficiently high, this leads to the formation of lamellar phases or structures.

The co-surfactant is preferably selected from the group consisting of alkoxylated C₈-C₁₈ fatty alcohols with a degree of alkoxylation ≤3, aliphatic C₆-C₁₄ alcohols, aromatic C₆-C₁₄ alcohols, aliphatic C₆-C₁₂ dialcohols, monoglycerides of C₁₂-C₁₈ fatty acids, monoglycerol ethers of C₈-C₁₈ fatty alcohols and mixtures thereof. Further suitable co-surfactants are 1-hexanol, 1 -heptanol, 1-octanol, 1,2-octanediol, stearyl monoglyceride and mixtures thereof

Fragrance alcohols such as for example geraniol, nerol, citronellol, linalool, rhodinol and other terpene alcohols or fragrance aldehydes such as lilial or decanal are likewise suitable as co-surfactants.

Preferred co-surfactants are C₁₂-C₁₈ fatty alcohols with a degree of alkoxylation ≤3. These co-surfactants are particularly well incorporated in the preferred associate of anionic and non-ionic surfactant.

Suitable alkoxylated C₁₂-C₁₈ fatty alcohols with a degree of alkoxylation of 3 comprise for example i-C₁₃H₂₇O(CH₂CH₂O)₂H, i-C₁₃H₂₇O(CH₂CH₂O)₃H, C₁₂₋₁₄ alcohol with 2 EO, C₁₂₋₁₄ alcohol with 3 EO, C₁₃₋₁₅ alcohol with 3 EO, C₁₂₋₁₈ alcohols with 2 EO and C₁₂₋₁₈ alcohols with 3 EO.

An electrolyte within the scope of the present invention is an inorganic salt. Preferred inorganic salts comprise sodium chloride, potassium chloride, sodium sulfate, sodium carbonate, potassium sulfate, potassium carbonate, sodium hydrogen carbonate, potassium hydrogen carbonate, calcium chloride, magnesium chloride and mixtures thereof. Particularly stable compositions are obtained when using sodium chloride or mixtures of sodium chloride and potassium sulfate.

Adding the inorganic salt supports the formation of lamellar structures. Additionally, the inorganic salt has an influence on viscosity, with the result that the viscosity of the liquid composition can be adjusted using the inorganic salt.

Preferably, the yield point is produced in the continuous method by metering co-surfactants and/or one or more electrolytes. This has the advantage that the components metered in the continuous method are present equally in the desired lamellar structure. In particular, the proportion of co-surfactants and/or electrolytes in the final liquid, surfactant-containing composition with a yield point is up to 15 wt.-%, preferably up to 10 wt.-%, even more preferably up to 5 wt.-%.

Preferably, dispersed particles are also added to the mixture in the continuous method. Dispersed particles within the scope of the present invention are not soluble in the solvent of the mixture from the batch method. However, they can be dispersed therein. The method according to the invention makes possible a homogeneous distribution and stable dispersion of these particles. According to the invention, these dispersed particles can be functional and/or have an aesthetic function. Functional materials influence the effect of the composition, whereas aesthetic materials influence only the appearance or odor. Preferably, the dispersed particles are visible particles. This means that the particles are clearly recognizable to the eye of the consumer in the composition (in the end-product) and can be distinguished from the remaining components. Preferably, colored particles are meant here. Such particles give the composition a particular effect which consumers appreciate. Particularly preferably, the composition can contain a dissolved dye and additionally colored particles which have a color which represents a contrast to the dissolved dye.

Within the scope of the present invention, functionally dispersed particles can be capsules, abrasive materials, granulates or compounds. The term capsule is understood to mean on the one hand aggregates with a core-shell structure and on the other hand aggregates with a matrix. Core-shell capsules (microcapsules, microbeads) contain at least one solid or liquid nucleus which is surrounded by at least one continuous shell, in particular a shell of polymer(s).

Sensitive, chemically physically incompatible and volatile components (=active ingredients) of the liquid composition can be enclosed, storage stable and transport stable, inside the capsules. For example, optical brighteners, surfactants, complexing agents, bleaching agents, bleach activators, dyes and fragrances, antioxidants, builders, enzymes, enzyme stabilizers, antimicrobial active ingredients, graying inhibitors, anti-redeposition agents, pH adjusters, electrolytes, laundry performance enhancers, vitamins, proteins, foam inhibitors and/or UV absorbers may be found in the capsules. The fillings of the capsules can be solids, or liquids in the form of solutions or emulsions or suspensions.

The dispersed particles can have a density which corresponds to that of the liquid composition. According to the invention, this means that the density of the dispersed particles corresponds to 90% to 110% of the composition. However, it is also possible that the dispersed particles have a different density. Nevertheless, because of the method according to the invention, it is also possible here to obtain a uniform dispersion of the particles in the composition. They can consist of different materials such as for example alginates, gelatins, celluloses, agar, waxes or polyethylenes. Particles which do not have a core-shell structure can also have an active ingredient in a matrix made of a matrix-forming material. Such particles are called “speckles”. The matrix is formed in these materials for example via gelation, polyanion-polycation interaction or polyelectrolyte-metal ion interaction and this is as well known in the prior art as the production of particles with these matrix-forming materials.

The composition according to the invention is in particular a personal-care product, washing or cleaning agent. Personal-care products, washing or cleaning agents within the scope of the present invention comprise cosmetics, household cleaners, laundry fabric softeners, washing agents for laundry, floor-care products, all-purpose cleaners, dishwasher detergents for both manual and dishwasher cleaning, heavy-duty detergent, shampoos, shower gels and bubble baths; preferably it is a washing or cleaning agent.

Compared with methods described in the prior art, the method according to the invention makes possible an effective cooling during production and thus an improved product stability. A targeted, uniform homogenization is made possible by a “one pass” production. Investment costs can be reduced as the product formulation involves a basic composition of the mixture produced in the batch method which can be produced in a simple method. This one-off produced mixture can then be used further for different products. This saves storage of batches of end-products which do not immediately go on sale. As a result, savings are made on energy and production costs, and simultaneously the capacities of existing systems are increased.

It is particularly advantageous to carry out the process according to the invention during the continuous differentiation accompanied by excess pressure. Excess pressure is considered to be a pressure of at least 0.1 bar above normal pressure. Excess pressure helps prevent the ingress of gases, in particular air, during the continuous further processing of the composition. A product is thus obtained which is more air-free than products which come from a batch process. The composition can thereby be metered more reliably and accurately. Because less gas is contained in the compositions according to the invention they have a higher density than comparison compositions.

### Embodiments

In both embodiments, the named components were produced in a batch reactor. Cooling took place by means of recirculation in a plate heat exchanger. The temperature was measured using a commercially available resistance thermometer PT100 which was mounted in the bottom region of the batch vessel, at the outlet of the batch.

### Embodiment 1

In the batch method, a mixture was produced with the following components:

| | |
|---|---|
| linear C₉ to C₁₃ alkylbenzene sulfonate | 26 wt.-% |
| C₁₂-C₁₈ fatty acids | 9 wt.-% |
| C₁₃ to C₁₅ oxo alcohol with 8 EO | 27 wt.-% |
| Monoethanolamine | 8 wt.-% |
| Water (VE) | 5 wt.-% |
| Glycols | 14 wt.-% |
| Phosphonates | 1 wt.-% |

Remainder: optical brighteners, dispersants, bitter substances, water from the raw materials

The named components were mixed together in a stirrer tank at a maximum temperature of 80° C. over a period of approximately 4 hours. Cooling to 30° C. then took place. The obtained mass already showed coagulations, after a short period of time, and phase separation was observed. Filling or a further processing was not possible.

### Embodiment 2

In the batch method, a mixture was produced with the following components:

| | |
|---|---|
| linear C₉ to C₁₃ alkylbenzene sulfonate | 26 wt.-% |
| C₁₂-C₁₈ fatty acids | 9 wt.-% |
| C₁₃ to C₁₅ oxo alcohol with 8 EO | 27 wt.-% |
| Monoethanolamine | 8 wt.-% |
| Water (VE) | 5 wt.-% |
| Glycols | 14 wt.-% |
| Phosphonates | 1 wt.-% |

Remainder: optical brighteners, dispersants, bitter substances, water from the raw materials

The named components were mixed together in a stirrer tank at a maximum temperature of 80° C. over a period of approximately 4 hours. The produced mixture was cooled to a temperature of 40° C. at the end. The obtained mixture was kept at 40° C. and remained clear and transparent over 4 weeks. The temperature which was measured by the thermometer at the batch outlet was critical. For cooling and further processing, the mixture at 40° C. was supplied directly from the batch tank into the continuous system via the outlet, adjacent to which the resistance thermometer was mounted. In so doing, it was checked, via a PT100 thermometer at the supply line in the continuous system, that the mixture also had a temperature of 40° C. at the inlet.

The 40° C. mixture was cooled simultaneously in a continuous system and prepared with different raw materials, such as dye, enzyme and perfume. The cooling in the continuous system took place to a temperature of from 20° C. to 25° C., in particular room temperature.

Then, filling into containers suitable for commercial sale took place at room temperature. Alternatively, the composition was stored at room temperature in intermediate storage. The compositions were stable.

What is claimed is:

1. A method for producing a liquid, surfactant-containing composition in which, in a first step, a mixture is produced in a batch method which then, in a second step, is further processed in a continuous method, wherein at the start of the continuous method, the mixture has a temperature in the region of 35° C. or more and a cooling takes place in the second step.

2. The method according to claim 1, wherein the mixture produced in the batch method has a solvent with a temperature of 40° C. or more.

3. The method according to claim 1, wherein in the batch method an exothermic reaction takes place.

4. The method according to claim 1, wherein the mixture produced in the batch method comprises 5 wt.-% to 40 wt.-% anionic surfactant and/or that the mixture produced in the batch method comprises 1 wt.-% to 27 wt.-% non-ionic surfactant.

5. The method according to claim 1, wherein the mixture produced in the batch method comprises 3.0 wt. % to 20 wt. % fatty acid.

6. The method according to claim 1, wherein the composition has a yield point of 0.01 to 50 Pa.

7. The method according to claim 1, wherein the proportion of all components of the composition which are produced in the batch method is 1 vol.-% to 99 vol.-%, relative to the total volume of the composition and/or that the proportion of all components of the composition which are produced in the continuous method is 1 vol.-% to 99 vol.-%, relative to the total volume of the composition.

8. The method according to claim 1, wherein the mixture produced in the batch method is free from defoamers and/or that the mixture in the continuous method is provided with defoamers.

9. The method according to claim 1, wherein, at the start of the continuous method, the temperature of the mixture is in the range from 40° C. to 90° C.

10. The method according to claim 1, wherein, at the end of the continuous method, the temperature of the composition is 35° C. or below.

11. The method according to claim 1, wherein, at the end of the continuous method, the composition is filled into containers.

12. A liquid, surfactant-containing composition obtained according to the method of claim 1.

13. A composition according to claim 12, wherein it is a personal-care product, a washing or cleaning agent.
